(19) United States
(12) Patent Application Publication
(10) Pub. No.: US 2026/0134033 A1
(43) Pub. Date: May 14, 2026

(54) METHOD FOR DETERMINING AND DISPLAYING OBJECT ASSOCIATED WITH MUSIC, AND MEDIUM

(71) Applicants: Lemon Inc., Grand Cayman (KY); Beijing Zitiao Network Technology Co., Ltd., Beijing (CN)

(72) Inventors: Rongrong LIU, Beijing (CN); Jingyi ZHANG, Beijing (CN); Pengcheng ZENG, Beijing (CN); Runfang LIN, Beijing (CN)

(21) Appl. No.: 18/945,772

(22) Filed: Nov. 13, 2024

(30) Foreign Application Priority Data
Nov. 13, 2023 (CN) 202311507956.6

(51) Int. Cl. G06F 16/68; G06F 16/635

(52) U.S. Cl. CPC G06F 16/686; G06F 16/635

(57) ABSTRACT

Embodiments of the present disclosure relate to a method and an apparatus for determining and displaying an object associated with music, an electronic device, and a medium. The method includes: determining a candidate object for a music content. The method further includes: obtaining music information of the music content and object information of the candidate object, where at least one of the music information and the object information comprises a plurality of types of information. In addition, the method includes determining, based the music information and the object information, the candidate object as a target object.

### CROSS-REFERENCE TO RELATED APPLICATION

This application claims priority to Chinese Application No. 202311507956.6 filed Nov. 13, 2023, the disclosure of which is incorporated herein by reference in its entirety.

### FIELD

Embodiments of the present disclosure generally relate to the field of computers, and more specifically, to a method and an apparatus for determining and displaying an object associated with music, a device, and a medium.

### BACKGROUND

With the development of the network technology and the boom of music contents, online media applications are used more and more frequently. When using online media applications, users can play music, favorite albums, follow artists, view comments, and the like, through the pages of the media applications.

In order to ensure the accuracy of user operations on media applications, it is required to provide users with accurate information through pages of the media applications. Considering a great number of music contents on the media application platform and a vast variety of information related to the music contents, it is crucial for the media application platform to accurately present the information related to the music contents on the page.

### SUMMARY

Embodiments of the present disclosure provide a method and an apparatus for determining and displaying an object associated with music, an electronic device and a medium.

In a first aspect of the present disclosure, there is provided a method for determining an object associated with music. The method includes determining a candidate object for a music content. The method further includes obtaining music information of the music content and object information of the candidate object, where the music information and/or the object information comprises a plurality of types of information. In addition, the method includes determining, based the music information and the object information, the candidate object as a target object.

In a second aspect of the present disclosure, there is provided a method for displaying an object associated with music. The method includes: in response to detecting a user click on a control of a target object, displaying a music content associated with the target object, where the target object is determined based on the method of any item in the first aspect. The method also includes: in response to the user click on the control of the music content, performing at least one of the following: in an event that the music content is a song, displaying a play page of the song comprising the target object; and in an event that the music content is an album, displaying an album page comprising the target object and at least one song in the album.

In a third aspect of the present disclosure, there is provided an apparatus for determining an object associated with music. The apparatus comprises: a candidate object determining module configured to determine a candidate object for a music content; an information obtaining module configured to obtain music information of the music content and object information of the candidate object, wherein the music information and/or the object information comprises a plurality of types of information; and a target object determining module configured to determine, based the music information and the object information, the candidate object as a target object.

In a fourth aspect of the present disclosure, there is provided an electronic device. The electronic device comprises: a processor; and a memory coupled to the processor, wherein the memory having instructions stored therein, and when executed by the processor, the instructions cause the electronic device to perform the method in the first or second aspect.

In a fifth aspect of the present disclosure, there is provided a computer readable storage medium. The computer readable storage medium having computer executable instructions stored thereon, where the computer executable instructions are executed by a processor to implement the method in the first or second aspect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other objectives, features, and advantages of respective embodiments of the present disclosure will become more apparent, through the following detailed description with reference to the accompanying drawings. Throughout the drawings, the same or similar reference symbols refer to the same or similar components, where:

FIG. 1 is a schematic diagram of an example environment where some embodiments of the present disclosure can be implemented;

FIG. 2 is a schematic diagram of a method for determining an object associated with music according to some embodiments of the present disclosure;

FIG. 3 is a schematic diagram of a process for determining an object associated with music according to some embodiments of the present disclosure;

FIG. 4 is a schematic diagram of a process of updating an object information database according to some embodiments of the present disclosure;

FIG. 5 is a schematic diagram of a page for presenting a video collection in a video application according to some embodiments of the present disclosure;

FIG. 6 is a schematic diagram of a page for playing a song in a music application according to some embodiments of the present disclosure;

FIG. 7 is a schematic diagram of a page for presenting a music content in a music application according to some embodiments of the present disclosure;

FIG. 8 is a block diagram of an apparatus for determining an object associated with music according to some embodiments of the present disclosure; and

FIG. 9 is a block diagram of an electronic device according to some embodiments of the present disclosure.

Throughout the drawings, the same or similar reference symbols refer to the same or similar components.

### DETAILED DESCRIPTION OF EMBODIMENTS

It would be appreciated that data involved in the present technical solution (including, but are not limited to, data per se, acquisition or use of data) should comply to the corresponding and related provisions of the laws and regulations.

Prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

Reference now will be made to the drawings to describe embodiments of the present disclosure in detail. Although some embodiments of the present disclosure are depicted in the drawings, it would be appreciated that the present disclosure could be implemented in various forms, and should not be construed as being restricted to those illustrated here. Rather, those embodiments are provided for a more thorough and complete understanding on the present disclosure. It is to be understood that the drawings and embodiments are provided only as examples, without suggesting any limitation to the protection scope of the present disclosure.

In the following description about the embodiments, the term “includes” and similar expressions are to be read as open terms that mean “includes, but is not limited to.” The term “based on” is to be read as “based at least in part on.” The term “an embodiment” or “the embodiment” is to be read as “at least one embodiment.” The terms “first,” “second,” and the like may refer to different objects or the same object unless indicated otherwise. Other definitions, implicit or explicit, may be included below.

Media application platforms receive a great number of music contents from music content providers every day, including songs, albums, packaged audio files, images, metadata and the like. Wherein, the metadata contains basic information on songs, albums, artists and the like, and by processing the metadata, the medial application platforms can provide users with reliable music experience. The metadata allow users to screen or filter music contents by artists, genres, albums and the like, and enable the media application platforms to standardize the music content management. For the media application platform, presenting metadata of music contents to users in a structured form can improve the users' efficiency for querying and searching for music contents and related information.

However, since the metadata of music contents are typically provided by the music content providers, the metadata are varied in terms of format, content and the like. During metadata processing, it is a crucial task to associate a song or an album with a correct artist in the artist profile database, or create a correct artist for a song or an album. In legacy, artist names are manually labeled as identification tags, so as to determine an artist associated with a song or an album. However, considering that different artists may have the same name or the same artist may have multiple names, the legacy association method is arduous and lab-intensive, and has a low accuracy. In the circumstance, users may be provided with wrong information and thus cannot accurately query and search for music contents and related information, thereby affecting the user experience.

According to the embodiments of the present disclosure, a candidate object of a music content is determined from metadata of the music content; music information related to the music content and object information corresponding to the candidate object are obtained; then, whether the candidate object is a target object associated with the music content is determined based on a combination of the music information and the object information. There is no need for manually filtering and determining the candidate object, making it possible to avoid association errors caused by different objects having the same name and the same object have multiple names. In this way, the embodiments of the present disclosure can improve the efficiency and accuracy for associating music with objects, and allow users to accurately query and search for music contents and related information, thereby improving the user experience.

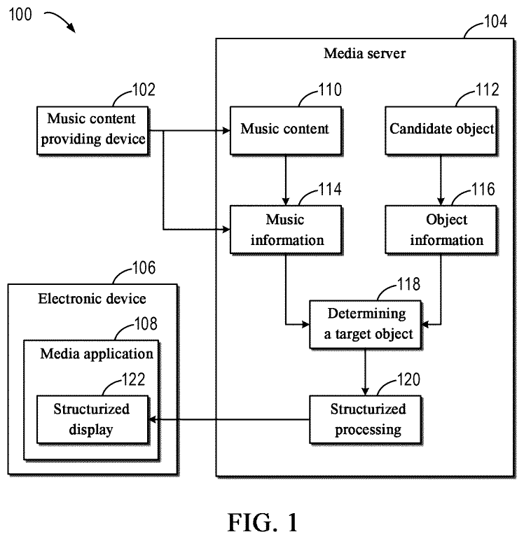

FIG. 1 illustrates a schematic diagram of an example environment 100 where some embodiments of the present disclosure can be implemented. As shown therein, the example environment 100 may include a music content providing device 102, a media server 104 and an electronic device 106, where: the media server 104 may be a computing system, a single server, a distributed server, a cloud-based server or the like; the electronic device 106 may be a user terminal, a mobile device, a computer or the like; the electronic device 106 has a media application 108 running thereon. In some embodiments, the media application 108 is a music application, and the media server 104 is a music server. Alternatively or in addition, the media application 108 is a video application, and the media server 104 is a video server.

Referring to FIG. 1, the music content providing device 102 is used to provide the media server 104 with a music content 110, metadata and the like. In some embodiments, the music content 110 may include a song and an album. The media server 104 receives the music content 110 and the metadata, and determines a candidate object 112 of the music content 110 from the metadata. In some embodiments, the candidate object 112 is an artist.

The media server 104 determines, from the metadata, music information 114 of the music content 110 and the object information 116 of the candidate object 112, where the music information 114 and/or the object information 116 includes various types of information. In some embodiments, the music information 114 includes a language, a genre, a released time and the like, of the music content 110, and the object information 116 includes a name, an alias and the like. Then, the media server 104 determines a target object 118, to determine, based on the music information 114 and the object information 116, whether the candidate object 112 is a target object associated with the music content 110. In some embodiments, the media server 104 determines whether an artist (corresponding to the candidate object 112) in the metadata provided by the music content providing device 102 is the actual artist (corresponding to the target object) of the song (corresponding to the music content 110).

Continuing with FIG. 1, after determining the target object, the media server 104 performs structurized processing 120 on the music information 114 and the object information 116, and then sends the music information 114 and the object information 116 subjected to the structurized processing 120 to the media application 108 in the electronic device 106; the media application 108 performs structurized display 122 to display the music information 114 and the object information 116 in a structurized manner to the user. Based on the information displayed on the page of the media application 108 in the structurized manner, the user can query and search for the music content 110 and the related information.

In this way, the candidate object 112 of the music content 110 is determined from the metadata of the music content 110; the music information 114 related to the music content 110 and the object information 116 corresponding to the candidate object 112 are then obtained; whether the candidate object 112 is the target object associated with the music content 110 can be determined based on the music information 114 and the object information 116. There is no need for manually filtering and determining the candidate object 112, making it possible to avoid association errors caused by different objects having the same name and the same object have multiple names. Accordingly, the present disclosure can improve the efficiency and accuracy of associating the music content 110 with the candidate object 112, and allow users to accurately query and search for the music content 110 and the related information, thereby improving the user experience.

It is to be understood that the architecture and functionality in the example environment 100 are described only for the exemplary purpose, without implying any limitation to the scope of the present disclosure. The embodiments of the present disclosure can be applied to other environment having a different structure and/or functionality.

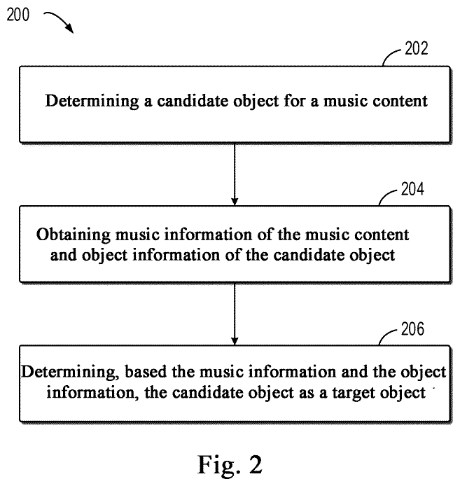

Reference will be made to FIGS. 2-9 to describe below in detail the process according to embodiments of the present disclosure. For ease of understanding, the specific data mentioned in the following description are provided only as examples, without limiting the scope of protection of the present disclosure. It would be appreciated that the embodiments as will be described later may further include additional acts and/or omit the shown acts, in which the scope of the present disclosure is not limited.

FIG. 2 is a flowchart of a method 200 for determining an object associated with music according to some embodiments of the present disclosure. In some embodiments, the media server 104 in FIG. 1 can act as the performer of the method 200.

In block 202, a candidate object for a music content is determined. In some embodiments, in the example environment 100 in FIG. 1, the media server 104 receives the music content 110, the metadata and the like from the music content providing device 102, and then determines a candidate object 112 of the music content 110 from the metadata. In some embodiments, the music content 110 may include a song and an album. In some embodiments, the candidate object 112 is an artist.

In block 204, music information of the music content and object information of the candidate object are obtained. In some embodiments, in the example environment 100 in FIG. 1, the media server 104 determines, from the metadata, the music information 114 of the music content 110 and the object information 116 of the candidate object 112, where the music information 114 and/or the object information 116 includes various types of information. In some embodiments, the music information 114 includes a language, a genre, a released time and the like, of the music content 110, and the object information 116 includes a name, an alias and the like.

In block 206, the candidate object is determined as the target object based on the music information and the object information. In some embodiments, in the example environment 100 as shown in FIG. 1, the media server 104 determines, based on the music information 114 and the object information 116, whether the candidate object 112 is a target object associated with the music content 110. In some embodiments, if multiple types of information corresponding to the music information 114 and the object information 116 satisfy a condition, the candidate object 112 can be determined as a target object. In some embodiments, the media server 104 determines whether an artist (corresponding to the candidate object 112) in the metadata provided by the music content providing device 102 is the actual artist (corresponding to the target object) of the song (corresponding to the music content 110).

According to the embodiments of the present disclosure, a candidate object of a music content is determined from metadata of the music content; music information related to the music content and object information corresponding to the candidate object are obtained; then, whether the candidate object is a target object associated with the music content is determined based on a combination of the music information and the object information. There is no need for manually filtering and determining the candidate object, making it possible to avoid association errors caused by different objects having the same name and the same object have multiple names. Accordingly, the embodiments of the present disclosure can improve the efficiency and accuracy of associating music with objects, and allow users to accurately query and search for music contents and related information, thereby improving the user experience.

In some embodiments, the object information may contain an international standard name identifier (ISNI). By using the international standard name identifier as unique tag information of an artist, whether an artist (corresponding to the candidate object) of a song (corresponding to the music content) is the actual artist (corresponding to the target object) is determined.

Alternatively or in addition, the object information may contain an organization ID (i.e., an ID of an organization to which the artist belongs). By determining whether the organization ID of the artist (corresponding to the candidate object) is identical to the organization ID of the artist in the object information database, the actual artist (corresponding to the target object) of the song (corresponding to the music content) is determined.

In some embodiments, related information can be obtained, from a supplementary database of a third-party organization, as a reference for determining the target object. Supplementary metadata for the music content are obtained from the supplementary database; if the supplementary metadata of the music content have passed the evaluation of the third-party organization, the music information and the object information are compared with the metadata in the supplementary database; if the two are consistent, it is determined that the target object is correct.

In some embodiments, possible artists may be pre-selected, and a whitelist may be set; a content, for example, the same name information under the same organization or the like, is used as a filter; the candidate object is filtered using the filter, to determine whether the candidate object is a target object. It would be appreciated that the candidate object may be pre-filtered using a filter, to reduce the computing cost for determining a target object.

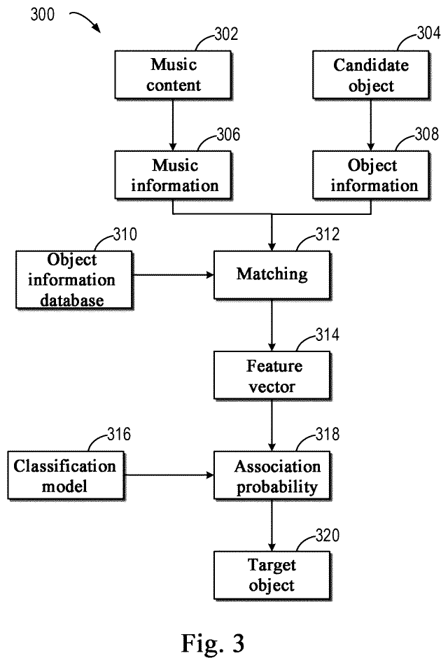

FIG. 3 is a schematic diagram of a process 300 for determining an object associated with music according to some embodiments of the present disclosure. As shown therein, in some embodiments, prior to performing the process 300, it is required to set an object information database 310 that stores therein object profiles (e.g. artist profiles) corresponding to different objects. In some embodiments, the artist profile includes, but is not limited to: an artist name, an artist alias, an artist company, a language, a region, a co-artist, a lyricist, a composer, a music genre, a released date and the like. In some embodiments, an artist profile is stored in the following form.

```
# Examples of an artist profile
{
  artist name: xxx,
  alias: [xxx, xxx, xxx],
  record labels: [xxx, xxx, xxx],
  languages: [xxx, xxx, xxx],
  regions: [xxx, xxx, xxx],
  co-artists: [xxx, xxx, xxx],
  composers: [xxx, xxx, xxx],
  lyricists: [xxx, xxx, xxx],
  music genres: [xxx, xxx, xxx],
  song/album released dates: [xxx, xxx, xxx],
}
```

Performing the process 300 includes: first, obtaining a music content 302 and a candidate object 304, where a candidate object 304 can be determined from metadata of the music content 302, for example. The metadata may be presented in the following form, from which it can be determined that the song title of the music content 302 is “ABC DEF:”

```
  <ResourceId>
  <ISRC>JPTO0465179</ISRC>
  </ResourceId>
  <DisplayTitleText IsDefault=“true”>ABC DEF </DisplayTitleText>
  <DisplayArtist SequenceNumber=“1”>
  <ArtistPartyReference>P1</ArtistPartyReference><DisplayArtistRole>MainArtist</Display
ArtistRole></DisplayArtist>
```

After determining the candidate object 304 of the music content 302, the music information 306 of the music content 302 and the object information 308 of the candidate object 304 can be extracted further from the metadata. In some embodiments, the music information 306 includes, but is not limited to, a song/album language, a song/album region, a song/album genre and a song/album released time, and the object information 308 includes, but is not limited to, an artist name (corresponding to the object name), an artist alias (corresponding to the object alias) and an artist company. In addition, auxiliary object information of an auxiliary object of the music content 302 can also be extracted from the metadata, including, but not limited to, a co-artist name, a lyricist name and a composer name.

Based on the music information 306 and the object information 308, information matching 312 is performed in the object information database 310. In some embodiments, the matching contents include: a number of artists having the same artist name as a candidate artist of a song/album in the object information database 310 (also referred to as number of matching results for the object name), a number of artists having the same artist alias as a candidate artist of a song/album in the object information database 310, whether a company of a candidate artist is in the object information database 310, whether a language of a song/album is in the object information database 310, whether a region of a song/album is in the object information database 310, whether a co-artist name of a song/album is in the object information database 310, whether a lyrist name of a song/album is in the object information database 310, whether a genre of a song/album is in the object information database 310, and whether a released time of a song/album is within a proper time range as compared with a released time of any previous song/album in the object information database 310.

After matching 312 is completed, a feature vector 314 (corresponding to a set of feature values) is constructed based on a matching result. In some embodiments, a matching result for any piece of information is recorded with a numeral (e.g. a numeral identical to a number of artists having the same name as a candidate artist of a song/album recorded in the object information database 310 (also referred to as feature value of an object name), and a numeral identical to a number of artists having the same alias as a candidate artist of a song/album recorded in the object information database 310), and a feature vector 314 is formed. The feature vector X in the following Equation (1) is an example of the feature vector 314:

$$X = [ \begin{matrix}{X}_{0} \\ {X}_{1} \\ {X}_{2} \\ {X}_{3} \\ {X}_{4} \\ {X}_{5} \\ {X}_{6}\end{matrix} ] = [ \begin{matrix}alias matching number \\ name matching number \\ l a nuage matching number \\ co - artist matching number \\ l yrist matching number \\ genre matching number \\ r e l eased time matching number\end{matrix} ] = [ \begin{matrix}2 \\ 1 \\ 1 \\ 3 \\ 1 \\ 2 \\ 1\end{matrix} ] \qquad Equation ( 1 )$$

After constructed, the feature vector 314 is input into a classification model 316, and an association probability 318 (also referred to classification result of a set feature values) is obtained by the classification model 316 based on the feature vector 314 through inference. Then, whether the candidate object 304 is the target object 320 associated with the music content 302 is determined based on the association probability 318. In some embodiments, the target object 320 may be an artist already existing in the object information database 310, and in this way, whether the candidate object 304 of the music content 302 is already present in the object information database 310 is determined. In some embodiments, the classification model 316 includes, but is not limited to, a naive Bayes mode, a decision tree model, a multi-layer perception model and the like.

In this way, the matching result of the music information 306 and the object information 308 in the object information database 310 can be expressed in a vectorized form, and the feature vector 314 can be classified simultaneously in conjunction with the classification model 316, thus improving the accuracy of expressing the matching result while reducing the computing cost. Moreover, with the feature vector 314 constructed based on multiple types of information, the accuracy of the association probability 318 can be improved.

In some embodiments, the candidate object is generally provided in plural. A plurality of association probabilities is determined through a plurality of feature vectors and then filtered based on a threshold, and the low association probabilities are deleted accordingly. Further, the plurality of filtered association probabilities is sorted, the association probability ranked at the top (i.e., the greatest or greater association probability) is selected, and the candidate object corresponding to the selected association probability is determined as the target object. In some embodiments, if there is no association probability satisfying the threshold condition, it can be determined that there is no target object corresponding to the music content (i.e., the object information database does not contain the same object as the candidate object), and an object profile corresponding to the candidate object is created in the object information database.

In some embodiments, referring to FIG. 3, a training process of the classification model 316 includes: obtaining a plurality of sample feature values corresponding to a plurality of label weights, where the label weights are determined based on an impact of the sample feature values on a label association probability (i.e., if the sample feature value has a greater impact on the label association probability, the label weight corresponding thereto is higher). Then, a plurality of training weights and a training association probability are determined by the classification model based on the plurality of sample feature values. Further, a loss between the plurality of label weights and the plurality of training weights and a loss between the label association probability and the training association probability are determined, and the parameters of the classification model are adjusted based on the two losses.

In this way, the classification model 316 can learn weights of different feature values in the feature vector 314. For example, the feature value corresponding to information having a high uniqueness, such as an artist name, artist alias or the like, may be set with a high weight while the feature value corresponding to information having a low uniqueness, such as a song language, a song region or the like, may be set with a low weight, to enable the classification model 316 to predict the association probability 318 and thus improve the accuracy of determining the target object 320.

In some embodiments, referring to FIG. 3, after determining the target object 320, the target object can be verified in combination with the international standard name identifier. Specifically, the international standard name identifier (also referred to as first identifier) of the target object 320 is obtained; whether the international standard name identifier (also referred to as second identifier) corresponding to the music content 302 is the same as the international standard name identifier of the target object 320 is then determined; if not the same, it is determined that the target object 320 contains an error. In this way, the accuracy of the target object 320 can be further improved.

In some embodiments, the music content includes a song and an album. After an artist corresponding to the song (also referred to as first object) and an artist corresponding to the album (also referred to as second object), if the artist corresponding to the song is identical to the artist corresponding to the album, whether the song is included in the album will be further determined. If the song is included in the album, the song can be added into the album. In this way, by preliminarily filtering the albums based on whether the artists are the same, the present disclosure can reduce the amount for computing whether the song and the album match while improving the efficiency of adding the song into the album.

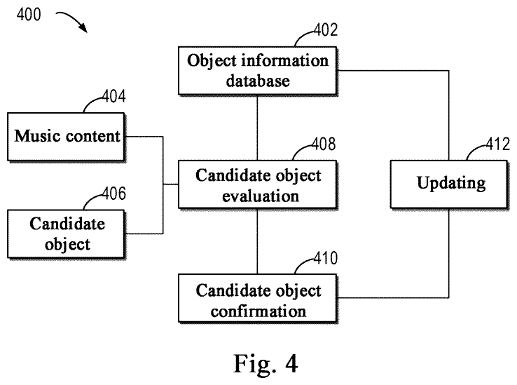

FIG. 4 is a schematic diagram of a process 400 of updating an object information database according to some embodiments of the present disclosure. After performing the process 300, the object information database 310 can be updated. In some embodiments, referring to FIG. 4, after performing candidate object evaluation 408 and candidate object confirmation 410 on the matching result in the information database 402, updating 412 is performed to update the candidate object (i.e., the target object at this time) to the object information database 402.

In some embodiments, referring to FIG. 4, if the object information database 402 does not include an object profile for the target object, an object profile for the target object can be added to the object information database 402 based on the music information and the object information. If the object information database 402 includes an object profile for the target object, the object profile for the target object in the object information database 402 can be updated based on the music information and the object information. For example, the information such as a language, an alias and the like in the object profile is added or adjusted. In this way, the timeliness of the object information database can be guaranteed, thereby improving the accuracy of determining the object associated with the music content.

In some embodiments, the object profile in the object information database can be maintained through maintenance information, where the maintenance information can be determined based on a sampling test result for the object information database obtained by the platform or feedback information for the object profile provided by a user. If it is determined based on the maintenance information that the object profile contains error information, the object profile is corrected, to improve the accuracy of the object profile.

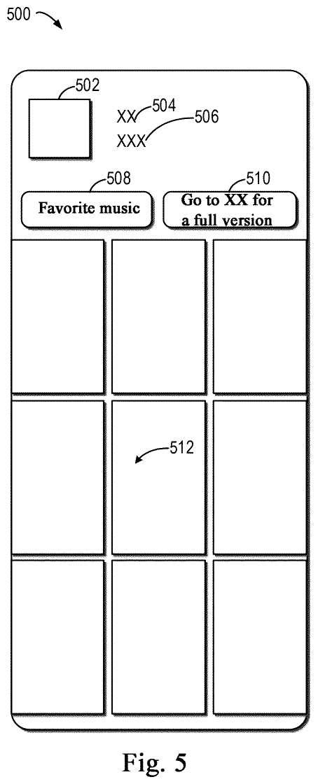

FIG. 5 is a schematic diagram of a page 500 for presenting a video collection in a video application according to some embodiments of the present disclosure. In some embodiments, referring to FIG. 5, the page 500 includes a plurality of covers 512 of a plurality of videos in the video collection. Moreover, the page 500 includes information of a song associated with a plurality of videos, including a cover 502 of the song, a song title 504 and an artist name 506. In some embodiments, the song is background music of a plurality of videos. A use can click a favorite music control 508 to favorite the song, or click a control 510 of Go to XX (a music application) for a full version to jump to the music application to play the song.

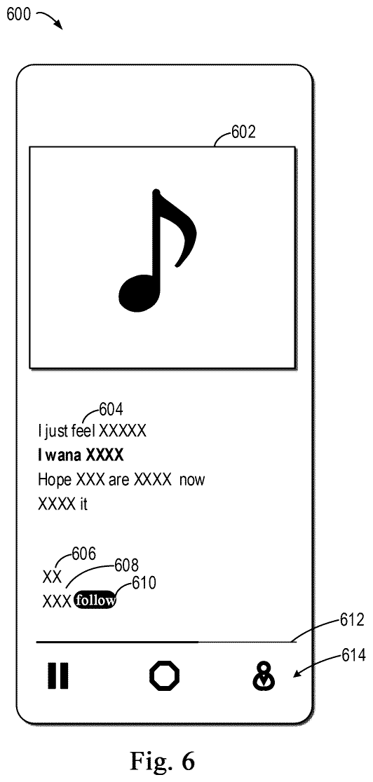

FIG. 6 is a schematic diagram of a page 600 for playing a song in a music application according to some embodiments of the present disclosure. In some embodiments, referring to FIG. 6, the page 600 includes a song cover 602, lyrics 604, a song title 606, an artist name 608, a follow control 610, a play progress bar 612 and an operation item component 614 (including controls for pause, play and homepage from left to right). By clicking the follow control 610, a use can follow an artist with the artist name 608.

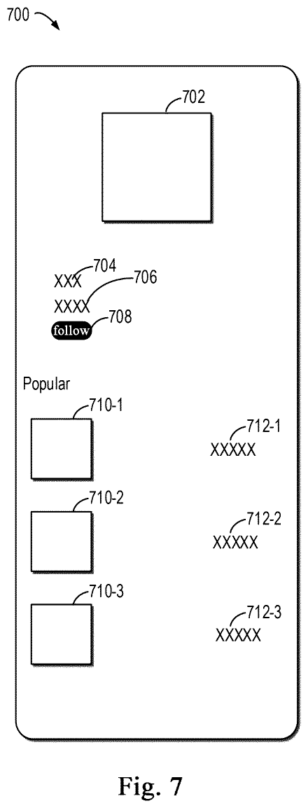

FIG. 7 is a schematic diagram of a page 700 for presenting a music content in a music application according to some embodiments of the present disclosure. In some embodiments, referring to FIGS. 6 and 7, if a user clicks the area of the artist name 608 (also referred to as target object control), the display jumps to the page 700. The page 700 includes an artist avatar 702, an artist name 704, other information 706 on the artist, and a follow control 708. In addition, the page 700 further presents a music content cover 710-1, a music content title 712-1, a music content cover 710-2, a music content title 712-2, a music content cover 710-3, and a music content title 712-3 for a music content (which may be a song or an album).

In some embodiments, if the music content is a song, the user clicks the area corresponding to the song (e.g. the area corresponding to the music content cover 710-1 or the music content name 712-1), and then enters a play page, which further includes artist information, to play the song. If the music content is an album, after the user clicks the area corresponding to the album, a plurality of songs in the album and artist information can be displayed on the album page; and when the user clicks a song in the album, the song will be played.

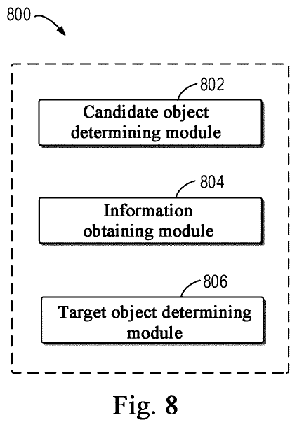

FIG. 8 is a block diagram of an apparatus 800 for determining an object associated with music according to some embodiments of the present disclosure. The apparatus 800 includes a candidate object determining module 802 configured to determine a candidate object for a music content. The apparatus 800 further includes an information obtaining module 804 configured to obtain music information of the music content and object information of the candidate object, where the music information and/or the object information contains a plurality of types of information. In addition, the apparatus 800 includes a target object determining module 806 configured to determine, based the music information and the object information, the candidate object as a target object.

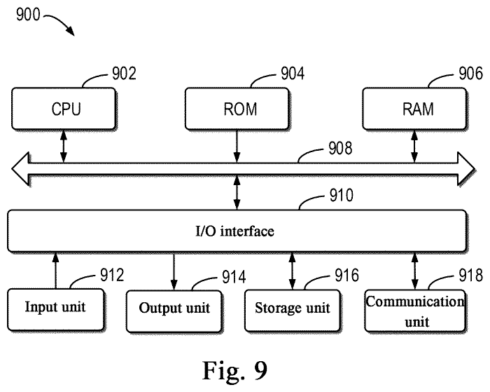

FIG. 9 is a block diagram of an electronic device 900 according to some embodiments of the present disclosure. The device 900 may be a device or apparatus as described here. As shown therein, the device 900 includes a central processing unit (CPU) and/or a graphics processing unit (GPU) 902, which can perform various appropriate acts and processing, based on computer program instructions stored in a read-only memory (ROM) 904 or computer program instructions loaded from a storage unit 916 to a random-access memory (RAM) 906. The RAM 906 stores therein various programs and data required for operations of the device 900. The CPU/GPU 902, the ROM 904 and the RAM 906 are connected via a bus 908 with one another. The input/output (I/O) interface 910 is also connected to the bus 908. Although not shown in FIG. 9, the device 900 may also include a coprocessor.

The following components in the device 900 are connected to the I/O interface 910: an input unit 912 such as a keyboard, a mouse and the like; an output unit 914 including various kinds of displays and a loudspeaker, etc.; a storage unit 916 including a magnetic disk, an optical disk, and etc.; a communication unit 918 including a network card, a modem, and a wireless communication transceiver, etc. The communication unit 918 allows the device 900 to exchange information/data with other devices through a computer network such as the Internet and/or various kinds of telecommunications networks.

Various methods and processes described above may be executed by the CPU/GPU 902. For example, in some embodiments, the method can be implemented as a computer software program that is tangibly included in a machine readable medium, e.g., the storage unit 916. In some embodiments, part or all of the computer programs may be loaded and/or mounted onto the device 900 via the ROM 904 and/or communication unit 918. When the computer program is loaded to the RAM 906 and executed by the CPU/GPU 902, one or more steps of the method or process as described above may be executed.

In some embodiments, the method and process as described above may be implemented as a computer program product. The computer program product may include a computer readable storage medium having computer readable program instructions thereon for implementing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

These computer readable program instructions may be provided to a processor unit of a general purpose computer, special purpose computer, or other programmable data processing device to produce a machine, such that the instructions, when executed via the processing unit of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored thereon includes an article of manufacture including instructions which implement aspects of the function/act specified in the flowchart and/or block diagram block or blocks.

The computer readable program instructions may also be loaded onto a computer, other programmable data processing device, or other devices to cause a series of operational steps to be performed on the computer, other programmable devices or other device to produce a computer implemented process, such that the instructions which are executed on the computer, other programmable device, or other devices implement the functions/acts specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which includes one or more executable instructions for implementing the specified logical function(s). In some alternative implementations, the functions noted in the block may occur out of the order noted in the figures. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Hereinafter, some example implementations of the present disclosure will be listed.

Example 1. A method for determining an object associated with music, comprising:
determining a candidate object for a music content;
obtaining music information of the music content and object information of the candidate object, wherein the music information and/or the object information comprises a plurality of types of information; and
determining, based the music information and the object information, the candidate object as a target object.

Example 2. The method of Example 1, further comprising:
determining, based on a matching result of the music information and the object information in an object information database, a set of feature values for the candidate object; and
in response to a classification result of the set of feature values satisfying a condition, determining the candidate object as the target object.

Example 3. The method of Example 1 or 2, wherein the object information comprises an object name of the candidate object, and determining the set of feature values for the candidate object comprises:
determining a number of matching results for the object name in the object information database; and
determining, based on the number of matching results for the object name, a feature value for the object name of the candidate object.

Example 4. The method of any of Examples 1-3, wherein the music information comprises at least one of a language, a genre, and a released time of the music content.

Example 5. The method of any Examples 1-4, wherein determining the set of feature values for the candidate object comprises:
determining an auxiliary object for the music content, wherein the auxiliary object comprises at least one of an artist, a lyricist, and a composer;
obtaining auxiliary object information of the auxiliary object; and
determining, based on a matching result of the auxiliary object information, the music information and the object information in the object information database, the set of feature values for the candidate object.

Example 6. The method of any of Examples 1-5, wherein the classification result comprises an association probability between the music content and the candidate object, and determining the candidate object as the target object comprises:
determining, by a classification model, a plurality of association probabilities between the music content and a plurality of candidate objects based on a plurality of sets of feature values;
filtering, based on a threshold condition, the plurality of association probabilities;
determining, based on a sorted result of a plurality of the filtered association probabilities, the candidate object corresponding to an association probability satisfying a sorting condition; and
determining the candidate object as the target object.

Example 7. The method of any of Examples 1-6, wherein a training process of the classification model comprises:
obtaining a set of sample feature values corresponding to a set of label weights, wherein the set of label weights is determined based on an impact of sample feature values in the set of sample feature values on a label association probability;
determining, by the classification model, a set of training weights and a training association probability based on the set of sample feature values;
determining a first loss between the set of label weights and the set of training weights, and a second loss between the label association probability and the training association probability; and
adjusting, based on the first loss and the second loss, parameters of the classification model.

Example 8. The method of any of Examples 1-7, further comprising:
in response to none of the plurality of association probabilities satisfying the threshold condition, determining that the music content does not contain a corresponding object.

Example 9. The method of any of Examples 1-8, wherein determining the candidate object as the target object comprises:
obtaining a first identifier corresponding to the target object;
determining whether a second identifier corresponding to the music content is the same as the first identifier; and
in response to the second identifier being different from the first identifier, determining that the target object contains an error.

Example 10. The method of any of Example 1-9, wherein the object information database is divided into a plurality of object profiles based on a plurality of objects, and the method further comprises:
in response to the classification result of the set of feature values satisfying a condition, updating, based on the music information and the object information, the object information database;
wherein updating, based on the music information and the object information, the object information database comprises:
in response to the object information database not containing an object profile for the target object, adding, based on the music information and the object information, an object profile for the target object into the object information database; or
in response to the object information database containing an object profile for the target object, updating, based on the music information and the object information, the object profile for the target object in the object information database.

Example 11. The method of any of Examples 1-10, further comprising:
obtaining maintenance information of the object profile for the target object, wherein the maintenance information is determined based on at least one of a sampling detection result of the object information database and user feedback information;
determining, based on the maintenance information, whether the music information and the object information in the object profile for the target object contain an error; and
in response to the music information and the object information in the object profile for the target object containing an error, correcting the object profile for the target object.

Example 12. The method of any of Examples 1-11, wherein the music content comprises a song and an album, and the method further comprises:
determining a first object of the song and a second object of the album;
in response to the first object being the same as the second object, determining whether the song is included in the album; and
in response to the song being included in the album, adding the song into the album.

Example 13. A method for displaying an object associated with music, comprising:
in response to detecting a user click on a control of a target object, displaying a music content associated with the target object, wherein the target object is determined based on the method of any of claims 1-12; and
in response to the user click on the control of the music content, performing at least one of the following:
in an event that the music content is a song, displaying a play page of the song comprising the target object; and
in an event that the music content is an album, displaying an album page comprising the target object and at least one song in the album.

Example 14. An apparatus for determining an object associated with music, comprising:
a candidate object determining module configured to determine a candidate object for a music content;
an information obtaining module configured to obtain music information of the music content and object information of the candidate object, wherein the music information and/or the object information comprises a plurality of types of information; and
a target object determining module configured to determine, based the music information and the object information, the candidate object as a target object.

Example 15. The apparatus of Example 14, further comprising:
a feature value determining module for determining, based on a matching result of the music information and the object information in an object information database, a set of feature values for the candidate object; and
a target object determining module for, in response to a classification result of the set of feature values satisfying a condition, determining the candidate object as the target object.

Example 16. The apparatus of Example 14 or 15, wherein the object information comprises an object name of the candidate object, and the feature value determining module is further configured to:
determine a number of matching results for the object name in the object information database; and
determine, based on the number of matching results for the object name, a feature value for the object name of the candidate object.

Example 17. The apparatus of any of Examples 14-16, wherein the music information comprises at least one of a language, a genre, and a released time of the music content.

Example 18. The apparatus of any of Examples 14-17, wherein the feature value determining module is further configured to:
determine an auxiliary object for the music content, wherein the auxiliary object comprises at least one of an artist, a lyricist, and a composer;
obtain auxiliary object information of the auxiliary object; and
determine, based on a matching result of the auxiliary object information, the music information and the object information in the object information database, the set of feature values for the candidate object.

Example 19. The apparatus of any of Examples 14-18, wherein the classification result comprises an association probability between the music content and the candidate object, and the target object determining module is further configured to:
determine, by a classification model, a plurality of association probabilities between the music content and a plurality of candidate objects based on a plurality of sets of feature values;
filter, based on a threshold condition, the plurality of association probabilities;
determine, based on a sorted result of a plurality of the filtered association probabilities, the candidate object corresponding to an association probability satisfying a sorting condition; and
determine the candidate object as the target object.

Example 20. The apparatus of any of Examples 14-19, wherein a training process of the classification model comprises:
a sample feature value obtaining module configured to obtain a set of sample feature values corresponding to a set of label weights, wherein the set of label weights is determined based on an impact of sample feature values in the set of sample feature values on a label association probability;
a weight and probability determining module configured to determine, by the classification model, a set of training weights and a training association probability based on the set of sample feature values;
a loss determining module configured to determine a first loss between the set of label weights and the set of training weights, and a second loss between the label association probability and the training association probability; and
a parameter adjustment module configured to adjust, based on the first loss and the second loss, parameters of the classification model.

Example 21. The apparatus of any of Examples 14-20, further comprising:
an associated object determining module configured, in response to none of the plurality of association probabilities satisfying the threshold condition, to determine that the music content does not contain a corresponding object.

Example 22. The apparatus of any of Examples 14-21, wherein the target object determining module is further configured to:
obtain a first identifier corresponding to the target object;
determine whether a second identifier corresponding to the music content is the same as the first identifier; and
in response to the second identifier being different from the first identifier, determine that the target object contains an error.

Example 23. The apparatus of any of Examples 14-22, wherein the object information database is divided into a plurality of object profiles based on a plurality of objects, and the apparatus further comprises:
an object information database updating module configured, in response to the classification result of the set of feature values satisfying a condition, to update, based on the music information and the object information, the object information database;
wherein the object information database updating module is further configured to:
in response to the object information database not containing an object profile for the target object, add, based on the music information and the object information, an object profile for the target object into the object information database; or
in response to the object information database containing an object profile for the target object, update, based on the music information and the object information, the object profile for the target object in the object information database.

Example 24. The apparatus of any of Examples 14-23, further comprising:
a maintenance information obtaining module configured to obtain maintenance information of the object profile for the target object, wherein the maintenance information is determined based on at least one of a sampling detection result of the object information database and user feedback information;
an error determining module configured to determine, based on the maintenance information, whether the music information and the object information in the object profile for the target object contain an error; and
a correction module configured, in response to the music information and the object information in the object profile for the target object containing an error, to correct the object profile for the target object.

Example 25. The apparatus of any of Examples 14-24, wherein the music content comprises a song and an album, and the apparatus further comprises:
an object determining module configured to determine a first object of the song and a second object of the album;
a song determining module configured, in response to the first object being the same as the second object, to determine whether the song is included in the album; and
a song adding module configured, in response to the song being included in the album, to add the song into the album.

Example 26. An apparatus for displaying an object associated with music, comprising:
a music content display module configured, in response to detecting a user click on a control of a target object, to display a music content associated with the target object, wherein the target object is determined based on the method of any of Examples 14-25; and
a play-page and album-page display module configured, in response to the user click on the control of the music content, to perform at least one of the following:
in an event that the music content is a song, displaying a play page of the song comprising the target object; and
in an event that the music content is an album, displaying an album page comprising the target object and at least one song in the album.

Example 27. An electronic device, comprising:
a processor; and
a memory coupled to the processor, wherein the memory having instructions stored therein, and when executed by the processor, the instructions cause the electronic device to perform the following acts:
determining a candidate object for a music content;
obtaining music information of the music content and object information of the candidate object, wherein the music information and/or the object information comprises a plurality of types of information; and
determining, based the music information and the object information, the candidate object as a target object.

Example 28. The electronic device of Example 27, wherein the acts further comprises:
determining, based on a matching result of the music information and the object information in an object information database, a set of feature values for the candidate object; and
in response to a classification result of the set of feature values satisfying a condition, determining the candidate object as the target object.

Example 29. The electronic device of Example 27 or 28, wherein the object information comprises an object name of the candidate object, and determining the set of feature values for the candidate object comprises:
determining a number of matching results for the object name in the object information database; and
determining, based on the number of matching results for the object name, a feature value for the object name of the candidate object.

Example 30. The electronic device of any of Examples 27-29, wherein the music information comprises at least one of a language, a genre, and a released time of the music content.

Example 31. The electronic device of any of Examples 27-30, wherein determining the set of feature values for the candidate object comprises:
determining an auxiliary object for the music content, wherein the auxiliary object comprises at least one of an artist, a lyricist, and a composer;
obtaining auxiliary object information of the auxiliary object; and
determining, based on a matching result of the auxiliary object information, the music information and the object information in the object information database, the set of feature values for the candidate object.

The Example 32. The electronic device of any of Examples 27-31, wherein the classification result comprises an association probability between the music content and the candidate object, and determining the candidate object as the target object comprises:
determining, by a classification model, a plurality of association probabilities between the music content and a plurality of candidate objects based on a plurality of sets of feature values;
filtering, based on a threshold condition, the plurality of association probabilities;
determining, based on a sorted result of a plurality of the filtered association probabilities, the candidate object corresponding to an association probability satisfying a sorting condition; and
determining the candidate object as the target object.

Example 33. The electronic device of any of Examples 27-32, wherein a training process of the classification model comprises:
obtaining a set of sample feature values corresponding to a set of label weights, wherein the set of label weights is determined based on an impact of sample feature values in the set of sample feature values on a label association probability;
determining, by the classification model, a set of training weights and a training association probability based on the set of sample feature values;
determining a first loss between the set of label weights and the set of training weights, and a second loss between the label association probability and the training association probability; and
adjusting, based on the first loss and the second loss, parameters of the classification model.

Example 34. The electronic device of any of Examples 27-33, wherein the acts further comprise:
in response to none of the plurality of association probabilities satisfying the threshold condition, determining that the music content does not contain a corresponding object.

Example 35. The electronic device of any of Examples 27-33, wherein determining the candidate object as the target object comprises:
obtaining a first identifier corresponding to the target object;
determining whether a second identifier corresponding to the music content is the same as the first identifier; and
in response to the second identifier being different from the first identifier, determining that the target object contains an error.

Example 36. The electronic device of any of Examples 27-35, wherein the object information database is divided into a plurality of object profiles based on a plurality of objects, and the acts further comprise:
in response to the classification result of the set of feature values satisfying a condition, updating, based on the music information and the object information, the object information database;
wherein updating, based on the music information and the object information, the object information database comprises:
in response to the object information database not containing an object profile for the target object, adding, based on the music information and the object information, an object profile for the target object into the object information database; or
in response to the object information database containing an object profile for the target object, updating, based on the music information and the object information, the object profile for the target object in the object information database.

Example 37. The electronic device of any of Examples 27-36, wherein the acts further comprise:
obtaining maintenance information of the object profile for the target object, wherein the maintenance information is determined based on at least one of a sampling detection result of the object information database and user feedback information;
determining, based on the maintenance information, whether the music information and the object information in the object profile for the target object contain an error; and
in response to the music information and the object information in the object profile for the target object containing an error, correcting the object profile for the target object.

Example 38. The electronic device of any of Examples 27-37, wherein the music content comprises a song and an album, and the method further comprises:
determining a first object of the song and a second object of the album;
in response to the first object being the same as the second object, determining whether the song is included in the album; and
in response to the song being included in the album, adding the song into the album.

Example 39. An electronic device, comprising:
a processor; and
a memory coupled to the processor, wherein the memory having instructions stored therein, and when executed by the processor, the instructions cause the electronic device to perform the following acts:
in response to detecting a user click on a control of a target object, displaying a music content associated with the target object, wherein the target object is determined based on the method of any of Examples 27-38; and
in response to the user click on the control of the music content, performing at least one of the following:
in an event that the music content is a song, displaying a play page of the song comprising the target object; and
in an event that the music content is an album, displaying an album page comprising the target object and at least one song in the album.

Example 40. A computer readable storage medium having computer executable instructions stored thereon, wherein the computer executable instructions are executed by a processor to implement the method of any of Examples 1-13.

Example 41. A computer program product tangibly stored on a computer readable medium and comprising computer executable instructions that cause a device to perform the method of any of Examples 1-13 when executed by the device.

Although the present disclosure has been described in language specific to structural features and/or methodological acts, it is to be understood that the present disclosure specified in the appended claims is not necessarily limited to the specific features or acts described above. Rather, the specific features and acts described above are disclosed as example forms of implementing the claims.

1. A method for determining an object associated with music, comprising:
determining a candidate object for a music content;
obtaining music information of the music content and object information of the candidate object, wherein at least one of the music information and the object information comprises a plurality of types of information; and
determining, based on the music information and the object information, the candidate object as a target object;
wherein the method further comprises:
determining, based on a matching result of the music information and the object information in an object information database, a set of feature values for the candidate object:
determining that a classification result of the set of feature values satisfies a condition; and
determining the candidate object as the target object.

2. (canceled)

3. The method of claim 1, wherein the object information comprises an object name of the candidate object, and determining the set of feature values for the candidate object comprises:
determining a number of matching results for the object name in the object information database; and
determining, based on the number of matching results for the object name, a feature value for the object name of the candidate object.

4. The method of claim 1, wherein the music information comprises at least one of a language, a genre, and a release time of the music content.

5. The method of claim 1, wherein determining the set of feature values for the candidate object comprises:
determining an auxiliary object for the music content, wherein the auxiliary object comprises at least one of an artist, a lyricist, and a composer;
obtaining auxiliary object information of the auxiliary object; and
determining, based on a matching result of the auxiliary object information, the music information and the object information in the object information database, the set of feature values for the candidate object.

6. The method of claim 1, wherein the classification result comprises an association probability between the music content and the candidate object, and determining the candidate object as the target object comprises:
determining, by a classification model, a plurality of association probabilities between the music content and a plurality of candidate objects based on a plurality of sets of feature values;
filtering, based on a threshold condition, the plurality of association probabilities;
determining, based on a sorted result of a plurality of the filtered association probabilities, the candidate object corresponding to an association probability satisfying a sorting condition; and
determining the candidate object as the target object.

7. The method of claim 6, wherein a training process of the classification model comprises:
obtaining a set of sample feature values corresponding to a set of label weights, wherein the set of label weights is determined based on an impact of sample feature values in the set of sample feature values on a label association probability;
determining, by the classification model, a set of training weights and a training association probability based on the set of sample feature values;
determining a first loss between the set of label weights and the set of training weights, and a second loss between the label association probability and the training association probability; and
adjusting, based on the first loss and the second loss, parameters of the classification mode.

8. The method of claim 6, further comprising:
determining that none of the plurality of association probabilities satisfying the threshold condition; and
determining that the music content does not contain a corresponding object.

9. The method of claim 6, wherein determining the candidate object as the target object comprises:
obtaining a first identifier corresponding to the target object;
determining that a second identifier corresponding to the music content is different from the first identifier; and
determining that the target object contains an error.

10. The method of claim 1, wherein the object information database is divided into a plurality of object profiles based on a plurality of objects, and the method further comprises:
determining that the classification result of the set of feature values satisfies a condition; and
updating, based on the music information and the object information, the object information database,
wherein updating, based on the music information and the object information, the object information database comprises:
determining that the object information database does not contain an object profile for the target object, and adding, based on the music information and the object information, an object profile for the target object into the object information database; or
determining that the object information database contains an object profile for the target object, and updating, based on the music information and the object information, the object profile for the target object in the object information database.

11. The method of claim 10, further comprising:
obtaining maintenance information of the object profile for the target object, wherein the maintenance information is determined based on at least one of a sampling detection result of the object information database and user feedback information;
determining, based on the maintenance information, that the music information and the object information in the object profile for the target object contain an error; and
correcting the object profile for the target object.

12. The method of claim 1, wherein the music content comprises a song and an album, and the method further comprises:
determining a first object of the song and a second object of the album;
determining that the first object is the same as the second object;
determining that the song belongs to the album; and
adding the song into the album.

13. A method for displaying an object associated with music, comprising:
detecting a user click on a control of a target object;
displaying a music content associated with the target object, wherein the target object is determined by the following:
determining a candidate object for a music content;
obtaining music information of the music content and object information of the candidate object, wherein at least one of the music information and the object information comprises a plurality of types of information; and
determining, based on the music information and the object information, the candidate object as a target object;
wherein the method further comprises:
determining, based on a matching result of the music information and the object information in an object information database, a set of feature values for the candidate object;
determining that a classification result of the set of feature values satisfies a condition;
determining the candidate object as the target object;
determining a user click on a control of the music content; and
performing at least one of the following:
in an event that the music content is a song, displaying a play page of the song comprising the target object; and
in an event that the music content is an album, displaying an album page comprising the target object and at least one song in the album.

14. (canceled)

15. The method of claim 13, wherein the object information comprises an object name of the candidate object, and determining the set of feature values for the candidate object comprises:
determining a number of matching results for the object name in the object information database; and
determining, based on the number of matching results for the object name, a feature value for the object name of the candidate object.

16. The method of claim 13, wherein the music information comprises at least one of a language, a genre, and a release time of the music content.

17. A non-transitory computer readable storage medium having computer executable instructions stored thereon, wherein the computer executable instructions are executed by a processor to cause the processor to:
determine a candidate object for a music content;
obtain music information of the music content and object information of the candidate object, wherein at least one of the music information and the object information comprises a plurality of types of information; and
determine, based on the music information and the object information, the candidate object as a target object;
wherein the computer executable instructions further comprise computer executable instructions to cause the processor to:
determine, based on a matching result of the music information and the object information in an object information database, a set of feature values for the candidate object:
determine that a classification result of the set of feature values satisfies a condition; and
determine the candidate object as the target object.

18. (canceled)

19. The non-transitory computer readable storage medium of claim 17, wherein the object information comprises an object name of the candidate object, and wherein the computer executable instructions to determine the set of feature values for the candidate object comprises computer executable instructions to cause the processor to:
determine a number of matching results for the object name in the object information database; and
determine, based on the number of matching results for the object name, a feature value for the object name of the candidate object.

20. The non-transitory computer readable storage medium of claim 17, wherein the music information comprises at least one of a language, a genre, and a release time of the music content.
